(19) United States
(12) Patent Application Publication
(10) Pub. No.: US 2023/0077695 A1
(43) Pub. Date: Mar. 16, 2023

(54) OPERATION OF A HYBRID VEHICLE

(71) Applicant: ZERO EMISSION SYSTEMS, LLC, COLLEYVILLE, TX (US)

(72) Inventors: Joseph M. Ambrosio, Smithtown, NY (US); Michael J. Kuhl, Holbrook, NY (US); Steven J. Massaro, Nesconset, NY (US)

(21) Appl. No.: 17/942,130

(22) Filed: Sep. 10, 2022

Related U.S. Application Data
(60) Provisional application No. 63/242,633, filed on Sep. 10, 2021.

(51) Int. Cl. B60W 20/40; B60W 10/06; B60W 10/08; B60W 10/02

(52) U.S. Cl. CPC B60W 20/40; B60W 10/06; B60W 10/08; B60W 10/02; B60W 2510/0638; B60W 2510/02; B60W 2510/244; B60W 2540/10; B60W 2520/00

(57) ABSTRACT

A system and method for operating a hybrid vehicle that shuts down an internal combustion engine during idle and slow speed operations and instead drives a power transmission with an electric traction motor. A vehicle operating at higher speeds, under increased operating demands, or other operating conditions automatically switches from electric propulsion to internal combustion engine propulsion. This operational mode is configurable and at all times seamless to the driver and vehicle operations. By designating the low speed, low demand operation of the vehicle to the more efficient electric mode, fuel consumption can be reduced, and overall vehicle efficiency can be maximized.

### CROSS REFERENCE TO RELATED APPLICATIONS

This is a nonprovisional application claiming the benefit of the priority date of U.S. Provisional Application No. 63/242,633, filed Sep. 10, 2021, entitled “Operation of a Hybrid Vehicle,” which is hereby incorporated herein by reference. This application is also related to U.S. Pat. Nos. 7,543,454, 7,600,595, 7,921,945, 7,921,950, 8,286,440, 8,565,969, 8,668,035, 9,457,792, 9,631,528, 9,707,861, and 9,758,146, all of which are hereby incorporated herein by reference in this patent application.

### BACKGROUND

### Background of the Disclosure

In certain circumstances, trucks powered by internal combustion engines (“ICE”) idle for long intervals and intermittently move. This may occur, for example, while waiting at ports, intermodal facilities, warehouses, and other staging areas. Moreover, it may occur for both picking up and dropping off loads at various facilities, and likewise, for deliveries in urban and suburban areas. As another example, trucks equipped with aerials or booms, like bucket trucks and boom trucks, idle for long intervals while the bucket or boom is extended so work can be done above ground level. This use of ICEs is in some ways undesirable. The fuel usage and emissions of heat, noise, and exhaust in these situations are very large relative to the distances that loads are moved or vehicle's hydraulic demand. However, an economically feasible alternative has not been developed, particularly for bucket trucks and heavy duty, tractor-trailer trucks, or semi-trucks (collectively referred to as “trucks” or “vehicles”). These vehicles can weigh more than 26,000 pounds and require a significant amount of energy to operate.

Thus, it should be appreciated that a need exists for a way to reduce fuel usage and emissions of heat, noise, and exhaust in connection with the use of ICEs for idling, for moving short distances, or for moving at relatively slow speeds. The need is especially acute for hauling large loads by trucks, particularly in situations such as in heavy traffic or around staging areas, where movement may be infrequent or relatively slow.

It is, of course, known to those skilled in the art to use an electric traction motor (also referred to as an “electric motor” or “ETM”) in a relatively small hybrid electric vehicle (“HEV”) to assist the ICE, or even briefly preempt the use of an ICE for traction, i.e., moving the HEV. There are, however, numerous obstacles to the use of ETMs, particularly for applications such as described above for trucks. For example, the loads for trucks in staging areas are potentially much greater than what is encountered by conventional HEVs.

Referring to FIG. 1A, there is illustrated a simplified block diagram of a conventional arrangement of a clutch and transmission for a vehicle. A transmission 122 has a case 127 defining a port 124 (also referred to as a “power take-off port” or “PTO port”), which may be covered by a removable access plate 121. ICE crankshaft 110 is coupled to transmission input shaft 125 via clutch 120. In other words, ICE is coupled via crankshaft 110 to a drivetrain that includes clutch 120 coupled to input 125 of transmission 122.

Transmission 122 has a transfer gear 130 coupled to input shaft 125. As shown in prior art FIG. 1B, a conventional PTO 140, which is a type of transfer device, has a case 142 defining an opening that matches port 124. Case 142 may be adapted for bolting to transmission case 127 so as to align case 142 with port 124 so that gear 141 of PTO 140 engages gear 130 of transmission 122, as is conventional. This arrangement conventionally enables takeoff of power from ICE crank shaft 110 via PTO shaft 143. This exemplary arrangement does not preclude the use of adapters between the PTO 140 and the transmission 122. Many PTO manufacturers sell gear adapters that change the rotational direction or change the PTO position (e.g., with a spacer housing and gear).

It is also common to disengage the clutch so that the vehicle can slowly move using the PTO to put power into its transmission shaft from an externally mounted ETM. The ETM is energized by a generator that is, in turn, driven by the vehicle's ICE. The prior art, however, only addresses a limited set of obstacles with regard to the present problem and also has the disadvantage that operation of the ICE ultimately supplies the power put into the PTO, so that the ICE must operate full time.

Thus, it should be appreciated that a need exists for a way to reduce fuel usage and emissions of heat, noise, and exhaust in connection with the use of ICEs for idling or for moving short distances or at relatively slow speeds. The need is especially acute for hauling large loads by trucks, particularly in situations such as in heavy traffic or around staging areas, where movement may be sporadic or relatively slow. The need also exists for a way to automatically control the ICE, ETM, clutch, transmission, and/or electrical control systems of modern vehicle design while operating at relatively slow speeds.

### SUMMARY OF THE DISCLOSURE

The present invention addresses the foregoing needs. According to one embodiment of the invention, a system for operating a hybrid vehicle includes a vehicle having a drivetrain with an ICE coupled to a transmission having a PTO. The transmission may be a manual, automatic, or automated manual. A transfer device couples an ETM to the transmission via the PTO. A control system enables the ETM in a certain configuration of the system to selectively power the drivetrain during at least certain intervals when the ICE is powered off (“EV Mode” or “second mode”). The control system also communicates with a controller area network and other components of the drivetrain and enables these parts to work efficiently together for traction, i.e., to move the vehicle.

In another aspect, the transmission has a case defining a port for accessing the transmission input and the transfer device has a case fixed to the transmission case such that the transfer device engages the transmission input for transferring the rotation of the electric motor.

In another aspect, the ICE is coupled via a clutch to an input shaft of the transmission.

In another aspect, the hybrid vehicle operating system has an actuator mechanically linked to the clutch. The actuator may be a linear actuator electrically, hydraulically, or pneumatically operated. The hybrid vehicle operating system selectively energizes the actuator so that the clutch is open when the hybrid vehicle is operating in EV Mode. Alternatively, the operating system selectively deenergizes the actuator so that the clutch is closed when the vehicle is powered by the ICE (“ICE Mode”). One skilled in the art will appreciate that the actuator may be configured such that energizing the actuator closes the clutch and deenergizing the actuator opens the clutch.

In another aspect, the hybrid vehicle operating system includes an actuator configured to automatically move the clutch to a position in which the ICE is disengaged from the transmission input responsive to a signal from the control system. The signal to automatically move the clutch may indicate initializing of an EV Mode in which movement of the vehicle is powered by the electrical motor. Alternatively, the actuator may be configured to automatically move the clutch to a position in which the ICE is engaged to the transmission input responsive to a signal from the control system. The signal to close the clutch may indicate initializing of an ICE mode in which movement of the vehicle is powered by the ICE.

In another aspect, the hybrid vehicle operating system includes a source device for supplying power to the electric motor. The source device may be electrically coupled to the ETM to supply power for the moving of the vehicle during at least certain intervals when the ICE is powered off. The source device may include a fuel cell. The source device may include a battery. The source device may include a battery and a fuel cell configured to charge the battery. One skilled in the art will appreciate that other source devices may be used to supply power to the ETM.

In another aspect, the hybrid vehicle operating system includes a motor controller, wherein the source device is electrically coupled to the ETM via the motor controller.

In another aspect, the source device includes a battery electrically coupled to the motor controller to supply electrical power for the ETM, wherein the electrical coupling of the fuel cell to the ETM is via the battery so that the fuel cell is operable to recharge the battery.

In another aspect, the hybrid vehicle operating system is configured to enable charging of the battery by the ICE when the hybrid vehicle is operating in ICE Mode. The configuration enabling charging of the battery by the ICE may include the transmission being engaged to the ICE via the clutch for mechanically transferring power from the ICE to the ETM via the clutch, so that the ETM is operable as a generator.

In another aspect, the hybrid vehicle operating system is configured such that while operating in EV mode, all necessary ICE Mode powering responsibilities are handled, including propulsion, braking, power-steering, 12V system charging (i.e., alternator function), engine block heating, cabin heating and cabin air-conditioning.

In another aspect, the hybrid vehicle operating system sends, receives, processes, modifies and/or simulates various operating data, including an engine operating time, an engine coolant temperature, a battery voltage, an air pressure, a vehicle speed, or an energy storage system state of charge. The control system may also be configured to enable power transfer from the ETM or the ICE to occur selectively. One skilled in the art will appreciate that other hybrid vehicle operating sensor signals are also received and/or processed by the control system.

In another aspect, the hybrid vehicle operating system has a controller area network (“CAN bus”) that allows electronic subsystems, the control system, and drivetrain components to be linked together and interact in a network. The CAN bus may be based on the SAE J1939 protocol and configured for communicating hybrid vehicle data, drivetrain data, operating conditions, or other vehicle information. For example, one skilled in the art will appreciate that the drivetrain data may include engine speed data, transmission input speed, an actual clutch position feedback data, a clutch actuator current feedback data, a commanded clutch position data and a clutch current limitation data. One skilled in the art will also appreciate the operating conditions may include an engine operating time, an engine coolant temperature, a hydraulic demand, a battery voltage, an air pressure, a vehicle speed, an acceleration rate, and an energy storage system state of charge.

The CAN bus may communicate such hybrid vehicle data, drivetrain data, operating conditions, or other vehicle information with an engine control module (“ECM”), an electronic clutch actuator (“ECA”), and a transmission control module (“TCM”). The CAN bus may also communicate with other drivetrain components, including, for example, a body controller, a brake controller, and an auxiliary inverter. One skilled in the art will appreciate that the CAN bus may also communicate other types of data with other hybrid vehicle components, modules, and systems.

In another aspect, the hybrid vehicle operating system has a control system that is configured to communicate with the CAN bus and other electronic subsystems and drivetrain components linked together in the network. The control system receives data and information sent on the network and uses that data and information as inputs to control system logic. When the vehicle is operating under preferred operating conditions, the control system logic modifies or simulates the data so that the hybrid vehicle operates in EV Mode. Alternatively, the control system logic may allow the data and information to pass through such that the vehicle operates in ICE Mode.

In another aspect, the hybrid vehicle operating system has a CAN Control Node (“CCN”) configured for communicating hybrid vehicle data, drivetrain data, or other vehicle information with the CAN bus, the control system, the TCM, and an electronic clutch actuator (ECA). The CCN may be configured selectively send, receive, pass-through, process, modify, simulate, and communicate the drivetrain data and the modified drivetrain data. The CCN may also selectively pass through all or part of the data and information without modifications or changes. One skilled in the art will appreciate that the CCN may also communicate other types of data with other hybrid vehicle parts, drivetrain components, modules, and systems.

In another aspect, the hybrid vehicle operating system has a second CAN Control Node (CCN2) configured for communicating hybrid vehicle data, drivetrain data, or other vehicle information with the CAN bus, the control system, the other CAN Control Node, and the TCM. The CCN2 may be configured to selectively send, receive, pass-through, process, modify, simulate, and communicate the drivetrain data and the modified drivetrain data. The CCN2 may also selectively pass through all or part of the data and information without modifications or changes. One skilled in the art will appreciate that the CCN2 may also communicate other types of data with other hybrid vehicle parts, drivetrain components, modules, and systems.

In another aspect, the hybrid vehicle operating system is electrically coupled to, and operable with, the motor controller to energize the electric motor responsive to the modified drivetrain data.

In another aspect, the modified drivetrain data is a variable demand signal, and the energizing of the electric motor includes variable energizing such that speed of the vehicle is modulated responsive to the variable demand signal.

In another aspect, the hybrid vehicle operating system includes a throttle and a variable impedance device. The energizing of the electric motor may include variable energizing. Thus, the demand signal may include a variable impedance signal from the variable impedance device, where the impedance is varied responsive to the throttle.

In another aspect, the hybrid vehicle operating system is electrically coupled to, and operable with, the motor controller to deenergize the electric motor responsive to unmodified drivetrain data from the control system, wherein the drivetrain data indicates operation of the ICE or a precursor to operation of the ICE. The drivetrain data may include a signal for starting the ICE. The signal may include a clutch position data. The signal may include an ICE rotation data. The shutdown signal may include an ICE ignition data.

In another aspect, the hybrid vehicle operating system includes an air compressor driven by the ICE for supplying air to a reservoir for a braking subsystem or other accessories installed in the vehicle, for example a boom. Accordingly, the system comprises an auxiliary air compressor for supplying air to the reservoir during at least certain times when the ICE is powered off. The system may also include an auxiliary air electric motor for driving the auxiliary air compressor and an air pressure switch coupled to the reservoir for turning on the auxiliary air electric motor responsive to low air pressure.

In another aspect, the hybrid vehicle operating system includes a hydraulic fluid pump driven by the ICE for supplying fluid to a steering subsystem or other accessories installed in the vehicle, for example a bucket. Accordingly, the system may comprise an auxiliary hydraulic fluid pump for supplying fluid to the power steering subsystem and other accessories during at least certain times when the ICE is powered off. The system also includes an auxiliary hydraulic fluid electric motor for driving the auxiliary hydraulic fluid pump and at least one limit switch for turning on the auxiliary hydraulic fluid electric motor responsive to a signal.

In another aspect, components of the hybrid system, including, for example a high voltage energy storage system, electric converters/inverters, low voltage, high voltage and AC junction boxes, auxiliary compressors, motors and pumps are housed in a rack enclosure. This rack sits just rear of a truck cabin and is mounted to the frame rails. Other components (electric traction motor, air conditioning compressor, and heater) are either mounted between the frame rails, or outboard of the driver's side frame rails. The air-conditioning evaporator and condenser can be found mounted within and to the roof of the cabin.

In another aspect, the hybrid vehicle operating system has a transmission with a transmission input shaft coupled by a clutch to an internal combustion engine. The transmission input shaft is further coupled to a drive shaft of an electric traction motor through a transfer gear set coupled to a power take-off port of the transmission. The operating system enables a control system that receives data from sensors monitoring operations of the hybrid vehicle. These sensors generate drivetrain data. The operating system also enables a first CAN control node that communicates the drivetrain data with an electronic clutch actuator, a transmission control module, and a controller area network. The operating system also enables a second CAN control node that communicates the drivetrain data with the transmission control module, and the controller area network. The hybrid operating system enables an electric operating mode of the hybrid vehicle in response to an electric drivetrain mode signal, and communicates a simulated clutch position and a simulated clutch current between the transmission control module, the first CAN control node, the second CAN control node, and the controller area network in response to the electric drivetrain mode signal. The electric operating mode is further enabled by signaling the electronic clutch actuator to disconnect the internal combustion engine from the transmission input shaft. The operating system communicates a simulated engine speed between the transmission control module, the first CAN control node, the second CAN control node, and the controller area network in response to the electric drivetrain mode signal. This simulated data signals the internal combustion engine to shut down in response to the electric drivetrain mode signal.

In another aspect, the hybrid vehicle operating system receives data from the sensors monitoring operations of the hybrid vehicle further comprises determining at least one of a vehicle run time, an engine coolant temperature, a battery voltage, an air pressure, an energy storage system state of charge, and a vehicle speed.

In another aspect, the hybrid vehicle operating system communicates a modified engine RPM speed data that the internal combustion engine is operating at a predetermined baseline idle RPM speed to the transmission control module. As an example of predetermined baseline idle RPM speeds, bucket trucks may preferably idle at a baseline of 500 RPM. Increased power demands may increase the engine speed to provide 200 HP at 2300 RPM and 385 HP at 5500 RPM. Parcel delivery trucks may preferably idle at a baseline of 450 RPM. Increased power demands may increase the engine speed to provide 200 HP at 4200 RPM. One skilled in the art will appreciate that other vehicles may have preferred engine idle speeds between 100 RPM and 1,000 RPM depending on the power demands, hydraulic needs or other operating conditions.

In another aspect, the hybrid vehicle operating system terminates the electric drivetrain mode signal when the vehicle speed is greater than 30 MPH.

In another aspect, the hybrid vehicle operating system communicates a simulated clutch position feedback between 100 and 120 degrees between at least the first CAN control node and the electronic clutch actuator.

In another aspect, the hybrid vehicle operating system communicates a simulated clutch motor current between 35 and 45 Amps between at least the first CAN control node and the electronic clutch actuator.

In another aspect, the hybrid vehicle operating system communicates a modified accelerator pedal percent data between at least the transmission control module and the controller area network.

In another aspect, the electric drivetrain mode signal may be terminated for safety reasons, for example, if the hood is open, if hydraulic pressures drop, or if battery levels are below a preferred threshold.

Other variations, objects, advantages, and forms of the invention will become apparent upon reading the following detailed description and upon reference to the accompanying drawings. For example, in one form of the invention features described herein are performed as in novel process steps, which may include processes for controlling a system such as described herein. In another form of the invention, a computer system includes a processor and a storage device connected to the processor. The storage device has stored thereon a program for controlling the processor. The processor is operative with the program to execute the program for performing a method, in whole or in part, which may include processes for controlling a system such as described herein. In another form of the invention, a computer program product is stored on a tangible, computer readable medium. The computer program product has instructions for executing by a computer system. When executed by the computer the instructions cause the computer to implement processes for controlling a system such as described herein.

### BRIEF DESCRIPTION OF THE DRAWINGS

FIG. 1A illustrates aspects of a prior art drivetrain;

FIG. 1B illustrates aspects of a prior art drivetrain with a PTO;

FIG. 2 illustrates certain components and certain mounting and engagement aspects of an operating system for a hybrid vehicle, according to embodiments of the present disclosure;

FIG. 3 illustrates a block diagram of additional aspects of an operating system for a hybrid vehicle, according to embodiments of the present disclosure;

FIG. 4 illustrates a illustrates certain aspects of an actuator and linkage to a main engine clutch for the operation of a hybrid vehicle

FIG. 5 illustrates a communication network for the operating system for a hybrid vehicle configured in accordance with embodiments of the present disclosure;

FIG. 6A illustrates a communication network the operating system for a hybrid vehicle configured in accordance with embodiments of the present disclosure;

FIG. 6B illustrates a communication network the operating system for a hybrid vehicle configured in accordance with embodiments of the present disclosure;

FIG. 6C illustrates message modifications in accordance with embodiments of the present disclosure of the operating system for a hybrid vehicle;

FIG. 6D illustrates message modifications in accordance with embodiments of the present disclosure;

FIG. 7. illustrates a computer system in which at least aspects of control processes of the invention may be implemented, according to an embodiment of the present invention of the operating system for a hybrid vehicle; and

FIG. 8 is a flow diagram of method steps used in one embodiment of operating a hybrid vehicle.

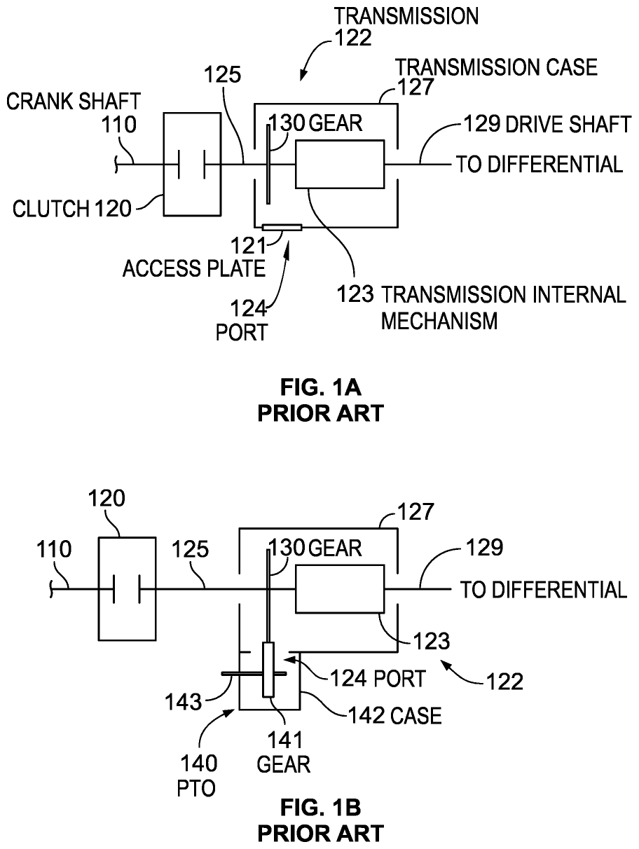

### DETAILED DESCRIPTION

In the following detailed description, reference is made to the accompanying drawings illustrating embodiments in which the disclosure may be practiced. It should be understood that other embodiments may be utilized and changes may be made without departing from the scope of the present disclosure. The drawings and detailed description are not intended to limit the disclosure to the particular form disclosed. On the contrary, the intention is to cover all modifications, equivalents, and alternatives falling within the spirit and scope of the present disclosure. Headings herein are not intended to limit the subject matter in any way.

According to embodiments of the present disclosure, the control system of the hybrid vehicle operates an electric traction system that includes an ETM to drive a vehicle's conventional or original equipment (“OEM”) transmission for traction when the vehicle is moving slowly, frequently idling, or when noise or pollution is a concern. Otherwise, the main traction engine, an ICE, may be started and used in a normal manner. During normal highway or street operation of the vehicle, the ETM may be used as a generator, which is powered by the main traction engine via the OEM transmission, in order to recharge batteries of the electric traction system. Or, the vehicle may be operated in a mode using the inertia of the vehicle during braking to recharge the batteries. The system may optionally include a hydrogen fuel cell that also generates electricity and thus reduces the size of batteries required to operate the system's electric traction motor.

An application of the disclosure is for trucks and vehicles traveling at speeds below approximately 20 MPH. However, in various embodiments, the disclosure may be applied at higher speeds and for different vehicles. For example, in accordance with alternative embodiments of the present disclosure, trucks may be driven at least partly by an ETM even at speeds above 20 MPH. Operating speeds above 20 MPH may be advantageous when near communities where noise or emissions are an issue, such as in heavy traffic and in densely populated communities near ports, for example, where smog and noise may be particularly problematic. One skilled in the art will appreciate other reasons may exist for driving a truck or vehicle at least partly by an electric traction motor at speeds above 20 MPH according to embodiments of the disclosure.

In yet another application of the disclosure, vehicles having truck-mounted aerial lifts, also referred to as bucket trucks or boom trucks, are powered. For example, the hydraulic system of the truck-mounted aerial lift may be powered by the ETM, when the power need is reduced. If the hydraulic demand increases, the control system may transition the hybrid vehicle to ICE Mode to satisfy the power requirements.

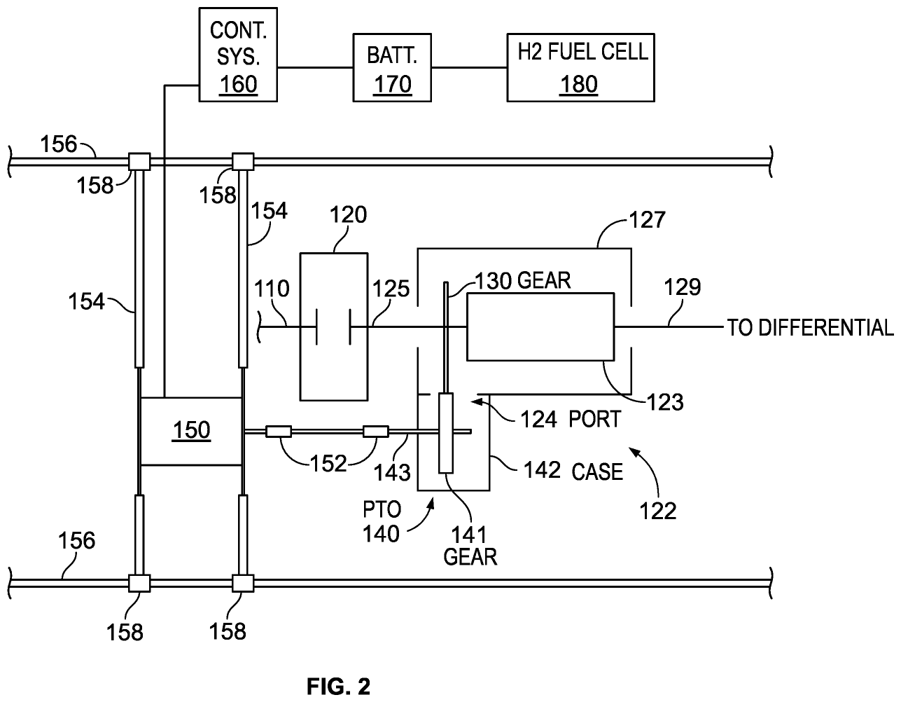

Referring now to FIG. 2, according to embodiments of the present disclosure, the ETM 150 may be mounted on frame rails 156 of a truck. The arrangement of FIG. 2 is structurally different than a conventional HEV arrangement, in which a hybrid transmission houses an ETM and a planetary gear set that couples the electric motor shaft to the transmission output shaft for transferring rotation from the ETM to the transmission output shaft, which is also driven by the ICE (not shown in FIG. 2). ETM 150 in FIG. 2 is external to transmission case 127 and thus may be too heavy and large to be reliably supported by case 127, since transmission case 127 cannot reliably withstand this much cantilevered weight. In the illustrated embodiment of the disclosure, brackets 154 may be mounted to frame rail 156 of the truck by pinch clamps 158. In turn, ETM 150 may be bolted to brackets 154 with sufficient clearance to permit the conventional drivetrain, which includes transmission 122, to freely move relative to frame rail 156 and other components.

ETM 150 is controlled by control system 160 and supplied by battery system 170, which is a type of source device (e.g., an electrical energy source). In accordance with alternative embodiments of the present disclosure, the battery system 170 may be, in turn, supplied by hydrogen fuel cells 180, which is another type of source device. ETM 150 is provided to power transmission output shaft 129 via gear 141 of PTO 140 that engages gear 130 on an input shaft 125 of transmission 122. That is, gear 141 is for transferring rotation from ETM 150 to drive shaft 129. PTO 140 houses gear 141 in a case 142 independent of, and removably bolted to, transmission case 127, such that gear 141 is aligned to engage gear 130 through port 124 of transmission case 127. Gear 141 may be implemented with any appropriate arrangement of multiple gears.

According to the illustrated embodiment, ETM 150 is configured to power the drivetrain of the vehicle in lieu of the truck's ICE, i.e., with the ICE shut off and/or disconnected from the drivetrain. Thus, in order for ETM 150 to drive transmission input shaft 125 without also turning the ICE, which is connected to crank shaft 110, it is desirable in at least some operational modes to disengage crank shaft 110 from input shaft 125. A clutch 120 may be selectively opened to disengage crank shaft 110 from input shaft 125 when the vehicle is operating in EV Mode.

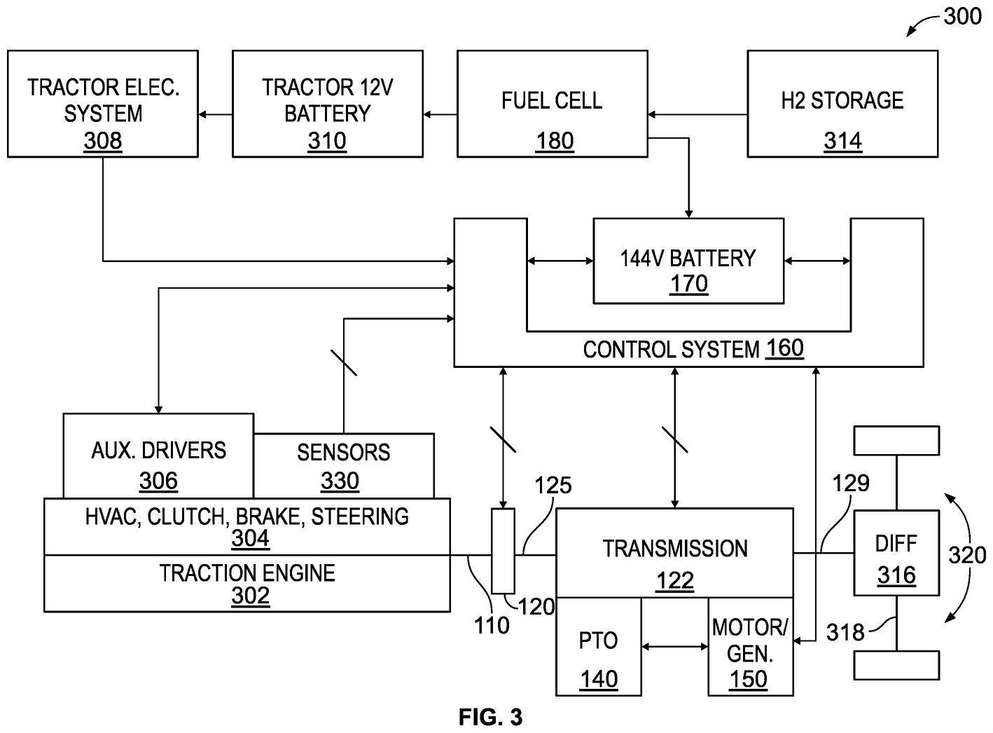

Referring now to FIG. 3, a block diagram is shown of an electric traction system for a vehicle 300, according to embodiments of the present disclosure. Vehicle 300 has a drivetrain, which includes a conventional arrangement of traction ICE 302 coupled to crankshaft 110, clutch 120, transmission input shaft 125, transmission 122, transmission output shaft 129, and differential 316. One skilled in the art will appreciate that drivetrains may include other components, including, for example, an engine control module, a transmission control module, an electric clutch actuator, a body controller, a brake controller, and an auxiliary inverter.

Differential 316 translates rotation of crankshaft 110 to axles 318 and, in turn, wheels 320. Differential 316 may be any type of known differential configuration. Vehicle 300 may also have a conventional DC battery 310 for supplying conventional electrical system 308 for ignition, lights, braking, power-steering, 12V system charging (i.e., alternator function), engine block heating, cabin heating and cabin air-conditioning, etc. Transmission 122 may be a manual, automatic, or automated manual transmission. Note that the control algorithms, circuitry, and signaling disclosed herein may be adapted by a person of ordinary skill in the art to implement embodiments of the present disclosure within any of the foregoing transmission configurations.

Vehicle 300 includes ETM 150 for driving transmission 122 via PTO 140, as previously described. ETM 150 may drive PTO 140 with shaft 143. ETM 150 may be directly powered by an AC output of a motor controller (not shown in FIG. 3) of control system 160, which may be powered by DC batteries 170. An optional hydrogen fuel cell 180 may be supplied by a canister 314 of compressed hydrogen. Besides charging batteries 170 to supply power for motor 150, fuel cell 180 may also charge conventional tractor system DC battery 310. Alternatively, there is a DC/DC converter to use the batteries 170 to charge the batteries 310.

In the illustrated embodiment of the disclosure, ETM 150 is an alternating current type, so that it is operable in reverse to generate electricity when ICE 302 is running and clutch 120 engages crankshaft 110 to transmission input shaft 125. When operating in this generating mode, ETM 150 may charges batteries 170 via control system 160. In accordance with other embodiments of the present disclosure, ETM 150 may be of the direct current type, an alternating current motor, a three phase induction motor, a linear induction motor, a permanent magnet motor, a switched reluctance motor or a combined switched reluctance/permanent magnet type rated at 60 kW and 80 kW peak.

The horsepower rating of ETM 150 may vary from one embodiment of the disclosure to the next, depending on the load that needs to be serviced and on the required speed and acceleration. As an example, conventional passenger electric vehicles generally weigh around 1800 pounds and require an electric motor of about 50 HP to achieve and maintain 80 MPH on electric power only. A tractor or semi may weigh more than 26,000 pounds, and a fully loaded heavy duty, tractor-trailer truck may weigh around 80,000 pounds. Operating vehicles of these weights require more horsepower to maintain desired speeds. Of course, the horsepower rating and corresponding rate depend upon the vehicle, load, and operating conditions. One skilled in the art will appreciate that the KWH capacity of batteries 170 may vary from one embodiment to the next, as may the KW capacity of fuel cell 180 and storage capacity of canister 314.

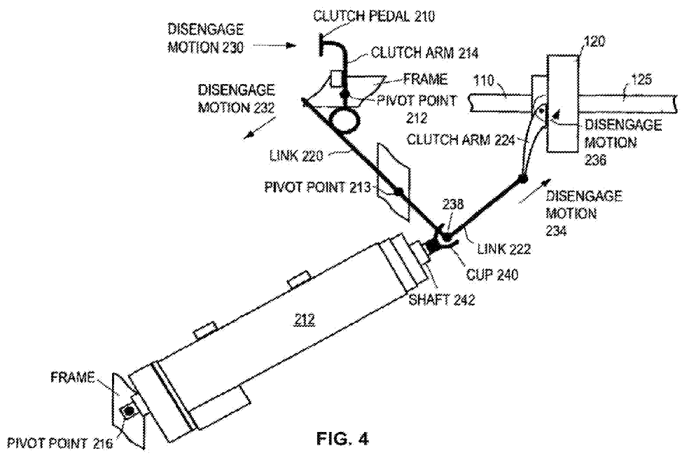

Referring now to FIG. 4, linkage of actuator 212 to clutch 120 is further illustrated. It should be appreciated that the illustration is generally indicative of linkage, but is somewhat schematic in nature. That is, in FIG. 4 some mechanical details may be omitted or depicted figuratively in order to more clearly depict particular features and aspects of how the illustrated arrangement operates.

In addition to depicting actuator 212 of the present invention and its associated linkage, FIG. 4 also depicts conventional linkage for conventional clutch pedal 210 and conventional clutch 120, as follows. In order to disengage clutch 120 a driver conventionally depresses conventional clutch pedal 210 in the vehicle cab, thereby causing disengage motion 230. Clutch pedal 210 is on clutch arm 214, which is rotatably fixed to pivot point 212, so that disengage motion 230 transmits disengage motion 232 via clutch arm 214 to link 220. Link 220 has a distal end opposite the engagement of link 220 to clutch arm 214 and rotatably connected 238 to link 222, as shown. Also, link 220 is rotatably fixed to pivot point 213. Thus, link 220 transmits disengage motion 232 to link 222, causing disengage motion 234 in link 222. Link 222 has a distal end opposite its coupling to link 220 and rotatably connected to clutch arm 224, which is rotatably coupled to clutch 120 and engages a throw out bearing (not shown) of clutch 120. Thus link 220 transmits disengage motion 234 to clutch arm 224, causing disengage motion 236 by clutch arm 224, which causes the throw out bearing of clutch 120 to disengage clutch 120, thereby disengaging crank shaft 110 from transmission input shaft 125.

According to the illustrated embodiment of the present invention, actuator 212 and its associated linkage are added to the conventional linkage described in the paragraph above, as follows. Actuator 212 is rotatably secured at one end to the chassis of the vehicle at pivot point 216. An extendable/retractable shaft 242 of actuator 212 (shown in FIG. 4 in its fully retracted position) at the other end of actuator 212 is secured by cup 240 to connection 238 of link 220 and 222, such that links 220 and 222 have sufficient freedom of movement to allow conventional operation by foot pedal 210, as described immediately above, but still enabling actuator 212 shaft 242 to also transmit disengage motion 234 to link 222 by driving shaft 242 toward its fully extended position.

To reiterate, the illustrated arrangement of FIG. 4 allows freedom for conventional movement of links 220 and 222 for conventional clutch pedal 210 operation of clutch 120 without extending or retracting shaft 242 of actuator 212, which has been added to the conventional linkage between clutch 120 and clutch pedal 210. That is, cup 240 captures coupling 238 loosely enough to permit this freedom of conventional movement but tightly enough so that shaft 242 remains engaged with coupling 238 throughout the range of conventional motion of clutch pedal 210 and the corresponding range of motion of coupling 238. Also, this maintained engagement enables actuator 212 to provide an alternative means for disengaging and reengaging clutch 120. For disengaging, actuator 212 drives link 222 in disengaging motion 234 by extending shaft 242. The conventional clutch 120 includes a spring return mechanism or mechanisms (not explicitly shown in FIG. 4) such that clutch 120 reengages merely by the retracting of shaft 242. That is, the spring return mechanism of clutch 120 moves clutch arm 224 to the reengaged position such that engagement of cup 240 and coupling 238 is maintained even though shaft 242 retracts.

The control system 160 (not shown) communicates the EV Mode signal that includes a clutch position signal that extends shaft 242 and opens the clutch 212 so that the transmission is powered by the ETM. In another aspect, the actuator 212 is responsive to an ICE Mode signal from the control system 160, wherein the ICE Mode signal indicates operation of the ICE or a precursor to operation of the ICE. The signal may include a signal for starting the ICE. The signal may include a clutch position signal that retracts the shaft 242 and closes the clutch 120 thereby permitting the ICE to drive shaft 125

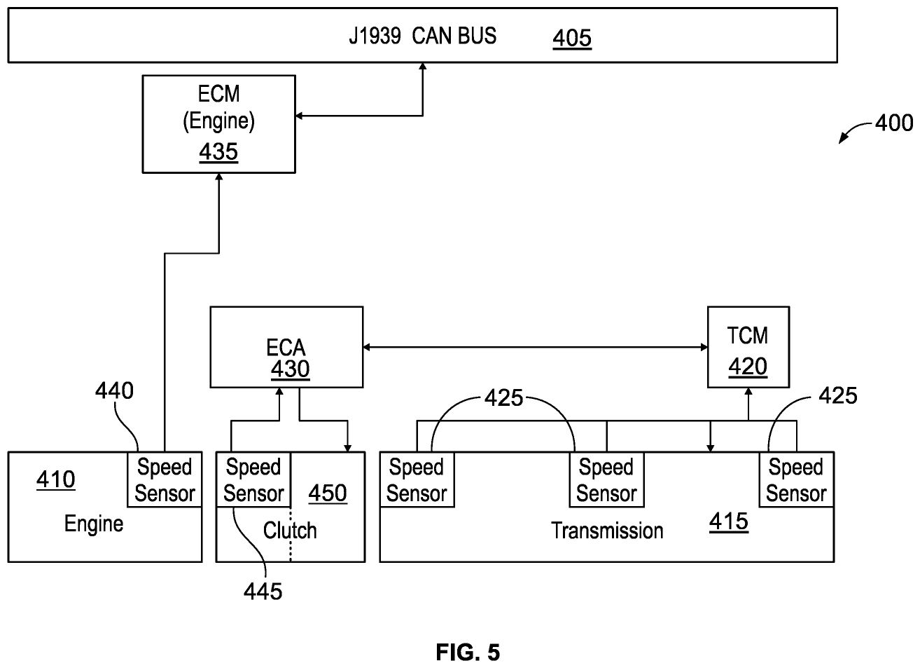

FIG. 5 illustrates a block diagram of a typical communication network within a vehicle powered by the ICE. The communication network 400 implements a data bus 405, such as a J1939 CAN bus, (also referred to as a “CAN bus” or “controller area network”), which allows communication between many of the OEM sub-systems, such as the engine 410, transmission 415, after-treatment, anti-lock braking system, etc. The controller area network 405 implements a method of communicating messages on a two-wire system widely used in the automotive industry. The messages may be defined by a SAE standard. Alternatively, any other suitable communication standard may be utilized, such as SAE-J1850 or Ethernet.

The transmission controller (“transmission control module” or “TCM”) 420 receives inputs from one or more speed sensors 425 implemented within the transmission 415, and is in communication with an electronic clutch actuator (“ECA”) 430 and an engine controller (“ECM”) 435 via CAN bus 405. There may be a separate OEM proprietary CAN bus communications between the TCM 420 and the ECA 430. The ECM 435 receives inputs from one or more speed sensors 440 within the engine 410. The ECA 430 may receive an input from a speed sensor 445 within the clutch 450, and also provides output signals to the clutch 450. Note that the TCM 420 and/or the ECM 435 may also receive input from the CAN bus 405 or other types of sensors than speed sensors 425, 440.

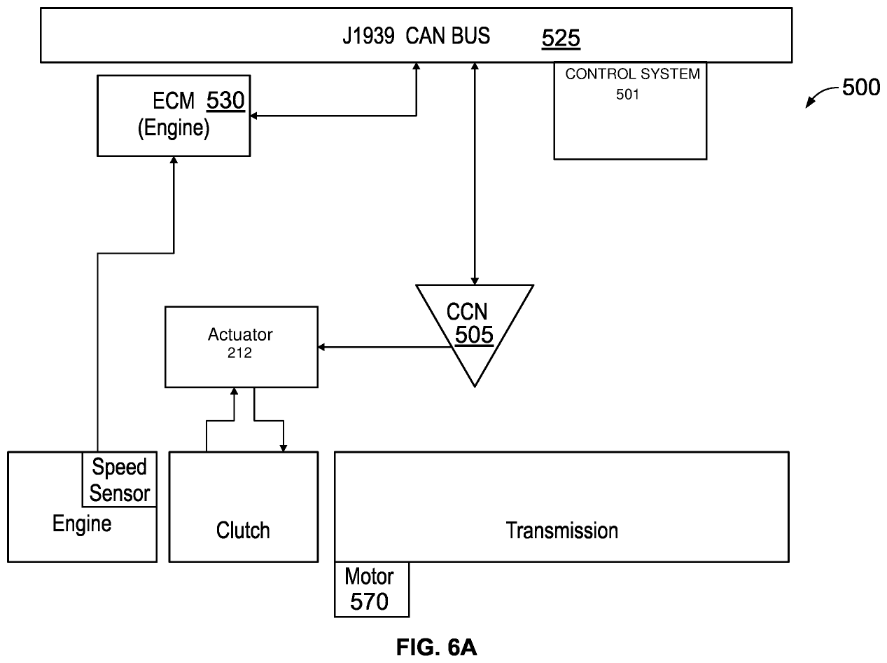

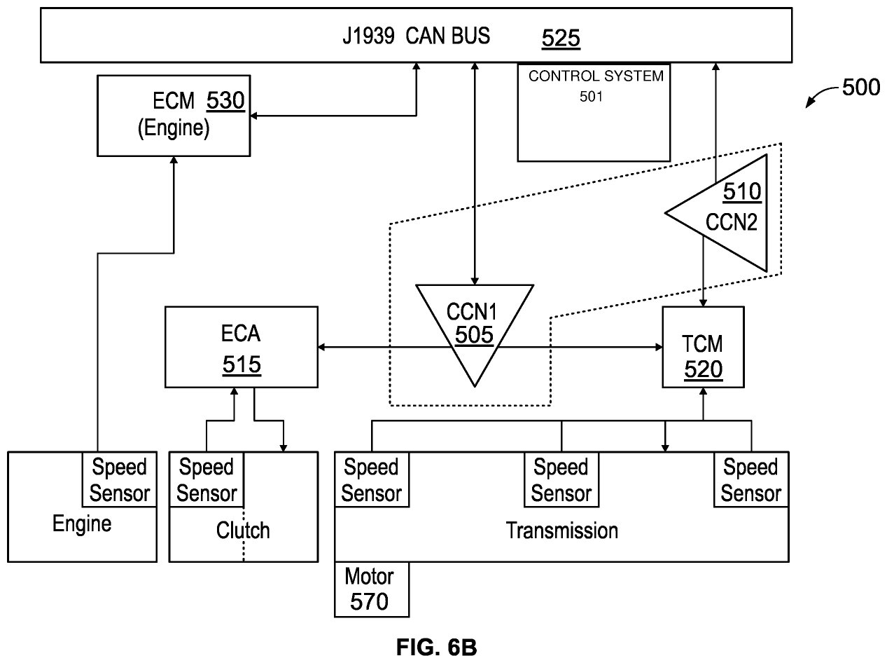

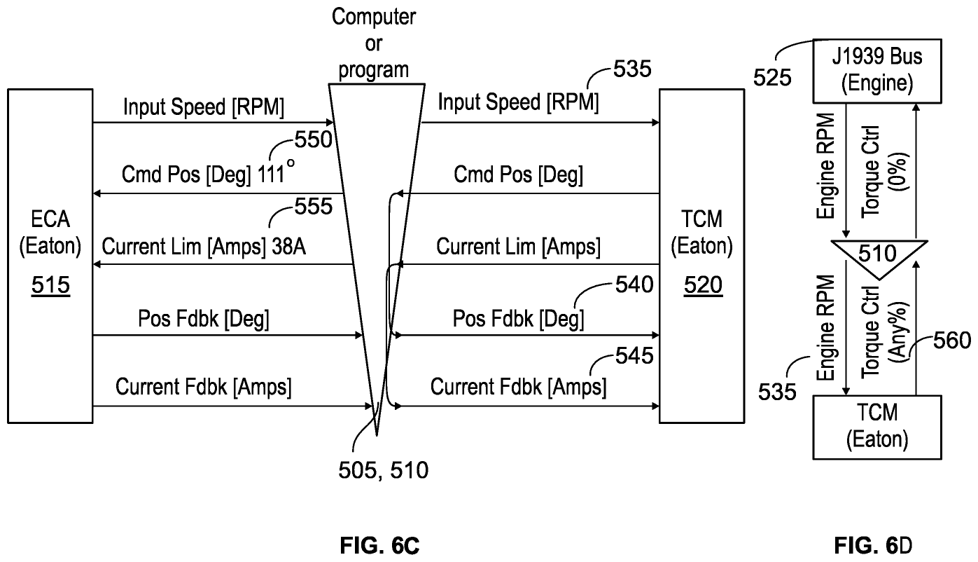

FIG. 6A illustrates a block diagram of a communication network 500 within an embodiment of a vehicle powered by an ICE that has been modified (e.g., retrofitted) with an ETM 570, such as the system described with respect to FIG. 3 (ETM 150). CAN control node (“CCN”) device 505 is inserted into the communication network that includes the CAN bus 525, the control system 501, the ECM 530, and drivetrain components, including, for example, the engine, clutch, and transmission. A CAN control node 505, may be in communication with the ECM 553 the actuator 212, the CAN bus 525, and other parts of the communication network. A controller configured to operate the system (e.g., the control system 501) may be in communication with the CAN bus 525 so that it can access and communicate with the engine, ECM 530, and actuator 212. The CCN 505 may be in data communication with the controller (e.g., the CCN 505 may be commanded by the control system 501 via the CAN bus 525). The CCN 505 device allow embodiments of the present disclosure to communicate hybrid vehicle data, drivetrain data, or other vehicle information, and modify and/or simulate such data before communicating the modified/simulated information between two or more components as needed to maintain OEM functionality while implementing ETM 570 and operating in EV Mode as described with respect to FIG. 3. The CCN 505 may also pass through the data and information, without modification, between two or more components as needed to maintain OEM functionality while operating in ICE Mode.

FIG. 6B illustrates a block diagram of another embodiment of a communication network 500 within a vehicle powered by an ICE that has been modified (e.g., retrofitted) with an ETM 570, such as the system described with respect to FIG. 3 (ETM 150). A second CAN control node (“CCN2”) device 510 is inserted into the communication network 500. The CAN control node 505, identified in FIG. 6B as “CCN1,” may be in communication with the ECA 515 the TCM 520, the CAN bus 525, the control system 501, and other parts of the communication network. CCN2 may be in communication with the TCM 520, the CAN bus 525, the control system 501, and other parts of the communication network. The controller configured to operate the system (e.g., the control system 501) may be in communication with the CAN bus 525 so that it can access and communicate with the engine, TCM 520, and ECA 515 (e.g., with the engine directly, the TCM 520 through the CCN2 510, and the ECA 515 through the CCN1 505). The CCN1 505 and CCN2 510 may be in data communication with the controller (e.g., both the CCN1 505 and the CCN2 510 may be commanded by the control system 160 via the CAN bus 525). These CCN 505, 510 devices allow embodiments of the present disclosure to communicate hybrid vehicle data, drivetrain data, operating information, or other vehicle information, and modify and/or simulate such data and information before communicating the modified/simulated information between two or more components as needed to maintain OEM functionality while implementing ETM and operating in EV Mode as described with respect to FIG. 3. These CCN 505, 510 may also pass through the data and information, without modification, between two or more components as needed to maintain OEM functionality while operating in ICE Mode.

In certain embodiments of the present disclosure, during each driver key-on startup of the vehicle, the control system initializes. During this startup the ICE is heated through its own idle combustion, but also may be heated through the embodiment's engine coolant heater, thus reducing the time to achieve a warm and therefore more efficient engine. When conditions for EV mode are met, which may include any one of a proper engine operating time between twenty seconds and sixty seconds, preferably greater than thirty seconds, engine coolant temperature greater than about 125-135 degrees Fahrenheit, preferably about 130 degrees Fahrenheit, battery voltage of about 12V to 14V, preferably about 13V, energy storage system state of charge between about 8% and 12%, preferably about 10%, air pressure about 90PSI to 110PSI, preferably about 100PSI, as well as the correct vehicle speed preferably between 0 and 18 mph, the control system turns off the ICE and begins operating in EV Mode.

In certain embodiments of the present disclosure, when the vehicle's speed increases to a specific point generally between 18 and 35 MPH, preferably about 24-25 MPH, the system turns on the ICE, and seamlessly blends then releases all propulsion from the ETM back to the ICE. The system also defers all auxiliary functions back to the ICE system. The system also returns propulsion and auxiliary functions to the ICE, and enters ICE Mode when engine operating time is less than about thirty seconds, engine coolant temperature less than about 125 degrees Fahrenheit, battery voltage less than about 12V to 14V, preferably about 13V, energy storage system state of charge less than about 8% and 12%, preferably about 10%, air pressure about 60PSI to 80PSI, preferably about 70 PSI, as well as vehicle speed greater than about 18 to 24 MPH.

In certain embodiments of the present disclosure, during operation of the vehicle 300 when the ICE 302 is on and actuated for powering the vehicle 300 and its drivetrain, the CCN1 505 and CCN2 510 may be configured (e.g., by the control system 160) to pass through all output drivetrain signals with no modifications. As such, the TCM 520 controls the ECA 515, while the ECA 515 controls the clutch. One skilled in the art will appreciate that while the ICE is on and powering the vehicle, the TCM controls many aspects of the vehicle, including gear shifts, clutch control during launching, upshifting, and downshifting, as well as instantaneous torque and speed limitations and commands. The TCM 520 listens to all engine messages and responds as usual with typical functionality.

Referring to FIGS. 6C and 6D, the two CCN devices 505, 510 may be configured to allow the control system, via the CAN bus 525, to receive engine and drivetrain messages and use as inputs to the control system logic, while also allowing the control system to keep the transmission operating and performing with typical functionality. When it is desired to switch the vehicle to EV mode, which includes shutting off or down the ICE, the CCN1 505 and CCN2 510 are configured (e.g., by the control system 160/501) to operate so that various engine and drivetrain data and information, including the input speed 535, clutch position 540, and clutch current feedback 545 signals to the TCM 520 are modified and/or simulated, and the command position 550 and current limitation 555 are modified and/or simulated to the ECA 515. For example, the CCN1 may be configured for communicating drivetrain data with the CAN bus 525, the TCM and the ECA. The CCN2 510 is configured to communicate drivetrain data with the TCM and CAN bus, and to disable the torque command/limit 560 from the TCM 520 to the ECM 530. The message from the TCM 520 can act as a limit or act as a command to the ECM 530.

Configurations of the CCN1 505 and CCN2 510 may be implemented from control signals from the control system 160, which is configured to operate in EV mode, where the ETM powers the transmission, as now described. By designating the low-speed operation of the vehicle to the more efficient EV mode, fuel consumption can be reduced, and overall vehicle efficiency can be maximized. This EV mode is configurable and at all times seamless to the driver and vehicle operations. In an embodiment, the EV mode may automatically be disabled if the hybrid vehicle's hood is open. Disabling the EV mode in this situation allows the ICE to continue to operate so that mechanical operations can be observed and maintenance conducted, if necessary. One skilled in the art will appreciate that other functions and features may be incorporated into the ICE and EV modes.

As the control system 160 within the vehicle 300 switches to EV mode, the system may be configured to command the transmission via the TCM to a neutral gear. (Note that embodiments of the present disclosure may be implemented so that the clutch is opened during a normal operation of the vehicle other than the EV mode.) In response, the TCM commands the ECA to open the clutch per typical drive gear functionality. The system commands the engine to shut down via the ECM. The system signals the ECA to keep the clutch open and interrupts all commands from the TCM to the ECA. The system commands the transmission via the TCM to return to a drive gear. The system signals the TCM a simulated engine speed even though the actual speed of the internal combustion engine is zero RPMs (since it has been shut down). Note that in accordance with certain embodiments of the present disclosure, such a simulated engine speed may be between 100 RPM and 1,000 RPM, and more preferably about 600 RPM, or any other predetermined engine speed as specified by the particular engine and or vehicle specifications. In another embodiment, the transmission input speed may be predetermined baseline idle RPM, or within a percentage of the predetermined baseline idle RPM. Next, the system signals the TCM that the clutch has closed as commanded, even though it is actually open.

Note that in certain vehicle configurations, the OEM TCM may perform what are referred to as “calibration checks,” where the TCM changes the command to the clutch and monitors the ECA position and motor control feedback to ensure the clutch mechanical system is still properly calibrated and working. In accordance with certain embodiments of the present disclosure, the system may provide for implementing calibration checks in which the mechanical system is simulated in order to successfully pass the TCM calibration checks of the mechanical clutch system. In such an instance, the system provides a simulated clutch position feedback signal and a simulated clutch motor current feedback signal.

In certain vehicle configurations, during shifting, the TCM may perform “shift monitoring,” where the TCM monitors the ECA clutch position, ECA motor current feedback, and various shaft speeds, and engine speed, to ensure the mechanical system is not out of safe ranges for the gear engagement process (e.g. significant speed difference between a transmission shaft speed and the engine speed). In such an instance, in accordance with embodiments of the present disclosure, the system provides for a simulated clutch position feedback, a simulated clutch motor current feedback, and a simulated engine speed.

As the control system 160/501 within the vehicle 300 switches to ICE mode, the system may be configured to command the transmission via the TCM to a neutral gear and keep the clutch open. In response, the TCM commands the ECA to open the clutch per typical drive gear functionality. The control system disables pedal torque data and sends the TCM a zero accelerator pedal percent data, this allows the TCM to send a message to hold idle speed. The control system then commands the ICE to turn on. The modified/spoofed TCM data is disabled and the TCM data subsequently matches RPM speed. The control system then disables engine speed spoofing data that is sent to the TCM, disables gear override, disables brake sense data and sends unmodified accelerator pedal percent to the TCM.

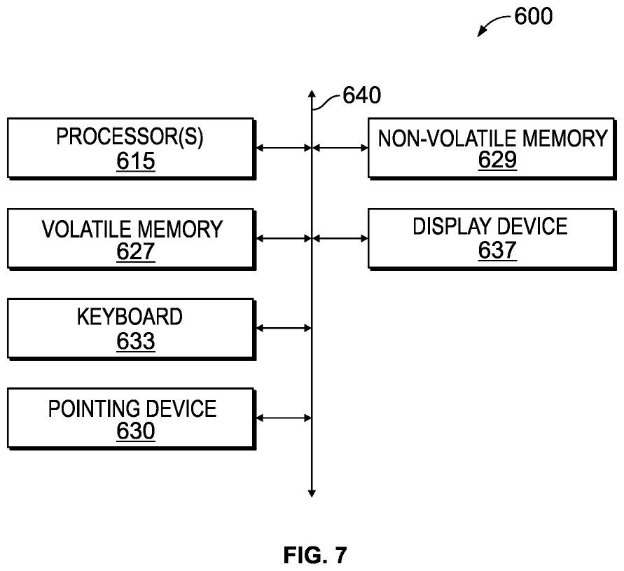

Referring now to FIG. 7, a computer system 600 in which control-related processes of the present disclosure may be implemented as illustrated, according to embodiments of the present disclosure. The computer system 600 does not necessarily need all of the hardware elements described herein but may instead be implemented as a microprocessor or microcontroller implementing the control system 160/501. It should be understood that the term “computer system” is intended to encompass any device having a processor that executes instructions from a memory medium, regardless of whether referred to in terms of an embedded controller, microcontroller, personal computer system (hardened or otherwise), or in some other terminology. Computer system 600 may include processor or processors 615, a volatile memory 627, e.g., RAM, and a nonvolatile memory 629. Memories 627 and/or 629 may store program instructions (also known as a “software program”), which are executable by processor(s) 615, to implement various embodiments of a software program in accordance with the present disclosure (e.g., the control processes described with respect to FIGS. 3 and 6A-6D). Processor(s) 615 and memories 627 and 629 may be interconnected by bus 640. An input/output adapter (not shown) may also be connected to bus 640 to enable information exchange between processor(s) 615 and other devices or circuitry. System 600 may be also adapted for at least temporary connection of a keyboard 633, pointing device 630, e.g., mouse, and/or a display device 637.

In the illustrated embodiment, nonvolatile memory 629 may include a disk for data storage and an operating system and software applications. In other embodiments, nonvolatile memory 629 is not necessarily a disk. The operating system may even be programmed in specialized chip hardware. Memory 629 may also include ROM, which is not explicitly shown, and may include other devices, which are also not explicitly shown, such as tapes.

Storing of data may be performed by one or more processes of computer system 600 and may include storing in a memory, such as memory 627 or 629, of the same computer system 600 on which the process is running or on a different computer system.

Additionally, at least some of the control-related processes of the present disclosure are capable of being distributed in the form of a computer readable medium of instructions executable by a processor to perform a method, i.e., process, such as described herein above. Such computer readable medium may have a variety of forms. The present disclosure applies equally regardless of the particular type of signal bearing media actually used to carry out the distribution. Examples of tangible computer readable media include recordable-type media such as a floppy disk, a hard disk drive, a RAM, and CD-ROMs. Examples of transmission-type media include digital and analog communications links.

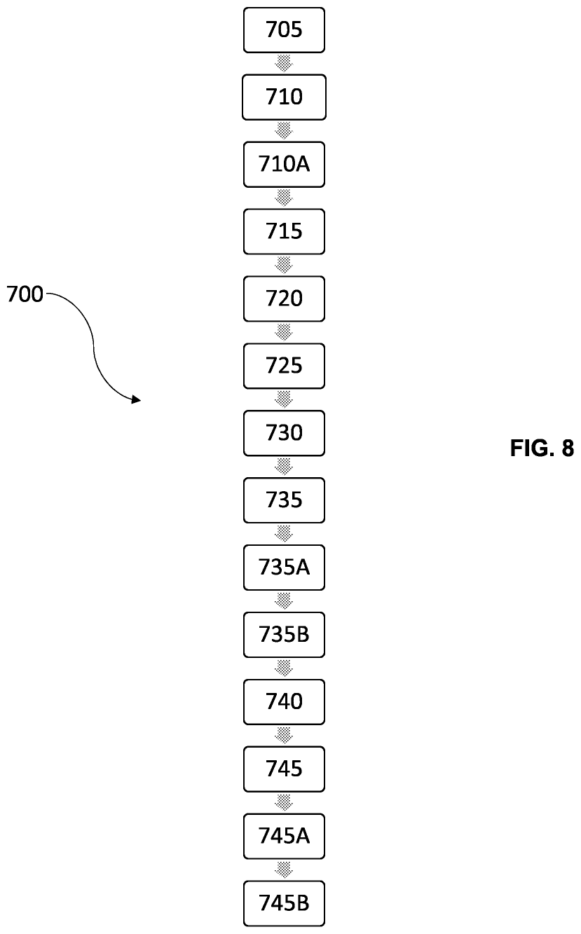

Referring now to FIG. 8 is a flow diagram chart 700 showing the steps of an exemplary method of operating a hybrid vehicle. In step, 705, a hybrid vehicle having a transmission with a transmission input shaft is by a clutch to an internal combustion engine, and the transmission input shaft is further coupled to a drive shaft of an electric traction motor through a transfer gear set coupled to a power take-off port of the transmission. In step 710, a control system receives data from sensors monitoring operations of the hybrid vehicle. Optionally, in step 710A, the control system receives one or more data from sensors monitoring operations of the hybrid vehicle including at least one of a vehicle run time, an engine coolant temperature, a battery voltage, an air pressure, an energy storage system state of charge, and a vehicle speed. The control system then generates drivetrain data. In step 715, a first CAN control node is in communication with the electronic clutch actuator, a transmission control module, and a controller area network. These components communicate drivetrain data. In step 720, a second CAN control node is in communication with the transmission control module and a controller area network. These components also communicate drivetrain data. In step 725, the control system transmits an electric drivetrain mode signal. This signal enables the electric operating mode of the hybrid vehicle. In step 730, the electronic clutch actuator disconnects the internal combustion engine from the transmission input shaft in response to the electric drivetrain mode signal. In step 735, a modified or simulated clutch position and a modified or simulated clutch current is communicated among the transmission control module, the first CAN control node, the second CAN control node, and the controller area network in response to the electric drivetrain mode signal. Optionally, in step 735A, a simulated clutch commanded position between 100 and 120 degrees is communicated between at least the first CAN control node and the electronic clutch actuator. Optionally, in step 735B, a simulated clutch motor current between 35 and 45 Amps is communicated between at least the first CAN control node and the electronic clutch actuator. In step 740, the internal combustion engine is shut down in response to the electric drivetrain mode signal. In step 745, a simulated engine speed is transmitted between the transmission control module, the first CAN control node, the second CAN control node, and the controller area network in response to the electric drivetrain mode signal. Optionally, in step 745A, simulated engine speed data that the internal combustion engine is operating at between 100 RPM and 1,000 RPM, preferably about 600 RPM is communicated to the transmission control mode. Optionally, in step 745B, a modified accelerator pedal percent data is communicated between at least the transmission control module and the controller area network.

Various embodiments may implement the one or more software programs in various ways, including procedure-based techniques, component-based techniques, and/or object-oriented techniques, among others. Specific examples include XML, C, C++ objects, Java, and commercial class libraries. Those of ordinary skill in the art will appreciate that the hardware depicted herein may vary depending on the implementation. The depicted example is not meant to imply architectural limitations with respect to the present disclosure.

In the description herein, a flow-charted technique may be described in a series of sequential actions. The sequence of the actions, and the party performing the actions, may be freely changed without departing from the scope of the teachings. Actions may be added, deleted, or altered in several ways. Similarly, the actions may be re-ordered or looped. Further, although processes, methods, algorithms, or the like may be described in a sequential order, such processes, methods, algorithms, or any combination thereof may be operable to be performed in alternative orders. Further, some actions within a process, method, or algorithm may be performed simultaneously during at least a point in time (e.g., actions performed in parallel), can also be performed in whole, in part, or any combination thereof.

Unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and resources described herein. This is done merely for convenience, and to give a general sense of the scope of the invention. This description should be read to include one, or at least one, and the singular also includes the plural, or vice versa, unless it is clear that it is meant otherwise. For example, when a single device is described herein, more than one device may be used in place of a single device. Similarly, where more than one device is described herein, a single device may be substituted for that one device.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described herein. All publications, patent applications, patents, and other references mentioned herein are incorporated by reference in their entirety, unless a particular passage is cited. In case of conflict, the present specification, including definitions, will control. In addition, the materials, methods, and examples are illustrative only, and not intended to be limiting.

To the extent not described herein, many details regarding specific materials, processing acts, and circuits are conventional, and may be found in textbooks and other sources within the computing, electronics, and software arts.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that is capable of” performing the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke a 35 U.S.C. § 112(f) interpretation for that unit/circuit/component.

1. A system for operating a hybrid vehicle comprising:
an internal combustion engine coupled via a clutch to an input shaft of a transmission having a power takeoff port;
an electric traction motor having a transfer device coupling the electric traction motor to the transmission via the power takeoff port;
a controller area network configured to communicate a drivetrain data between at least one drivetrain component, a control system, and a CAN control node;
the control system configured to communicate the drivetrain data and a modified drivetrain data with the controller area network and the CAN control node, wherein the modified drivetrain data is modified or simulated drivetrain data;
the CAN control node configured to selectively send, receive, pass-through, process, modify, simulate, and communicate the drivetrain data and the modified drivetrain data;
wherein in response to vehicle operating conditions received by the controller area network, the control system selects between (i) communicating the drivetrain data so that the hybrid vehicle operates in a first mode in which the transmission is powered by the internal combustion engine, and (ii) signaling the CAN control node to modify or simulate the drivetrain data and communicate the modified drivetrain data so that the hybrid vehicle operates in second mode in which the transmission is powered by the electric traction motor.

2. The system of claim 1, wherein the at least one drivetrain component is selected from a group comprising an internal combustion engine, an engine control module, a transmission control module, an electric clutch actuator, a body controller, a brake controller, and an auxiliary inverter.

3. The system of claim 1, further comprising an actuator configured to move the clutch to an open position in which the internal combustion engine is disengaged from the transmission input shaft responsive to the modified drivetrain data.

4. The system of claim 2, wherein the drivetrain data comprises engine speed data generated by the engine control module.

5. The system of claim 2, wherein the drivetrain data comprises a transmission input speed, an actual clutch position feedback data, and a clutch actuator current feedback data generated by the electronic clutch actuator.

6. The system of claim 2, wherein the drivetrain data comprises a commanded clutch position data and a clutch current limitation data generated by the transmission control module.

7. The system of claim 2, wherein the modified drivetrain data comprises a modified commanded position data and a modified current limitation data communicated between the CAN control node and the electronic clutch actuator.

8. The system of claim 2, wherein the modified drivetrain data comprises a modified transmission input speed data, a modified commanded clutch position data, and a modified clutch current limitation data communicated between the CAN control node and the transmission control module.

9. The system of claim 2, further comprising a second CAN control node configured to selectively send, receive, pass-through, process, modify, simulate, and communicate the drivetrain data and the modified drivetrain data between the control system, the controller area network, and the transmission control module.

10. The system of claim 9, wherein the modified drivetrain data comprises a modified engine RPM speed data communicated between the second CAN control node and the transmission control module.

11. The system of claim 10, wherein the modified engine RPM speed data is a predetermined baseline idle engine RPM speed data.

12. The system of claim 1, wherein the control system is further configured to deenergize the electric traction motor responsive to the drivetrain data, wherein a drivetrain data signal indicates operation of the internal combustion engine, a precursor to operation of the internal combustion engine, or a signal for starting the internal combustion engine.

13. The system of claim 1, wherein the operating condition is at least one selected from a group comprising an engine operating time, an engine coolant temperature, a hydraulic demand, a battery voltage, an air pressure, a vehicle speed, an acceleration rate, and an energy storage system state of charge.

14. The system of claim 1, wherein the transmission comprises a manual transmission.

15. The system of claim 3, wherein the actuator comprises a linear actuator selected from the group comprising an electric actuator, a hydraulic actuator, and a pneumatic actuator.

16. The system of claim 1, further comprising a source device supplying power to the electric traction motor.

17. The system of claim 1, wherein the controller area network is a J1939 CAN bus.

18. The system of claim 1, wherein the electric traction motor is selected from a group comprising a direct current type motor, an alternating current motor, a three phase induction motor, a linear induction motor, a permanent magnet motor, a switched reluctance motor, and a combined switched reluctance/permanent magnet type motor.

19. The system of claim 1, wherein the clutch is open and the internal combustion engine is off in the second mode.

20. The system of claim 13, wherein the hybrid vehicle transitions from the second mode to the first mode when the vehicle speed is between 18 and 35 MPH, and preferably at 24 MPH.

21. The system of claim 13, wherein the hybrid vehicle transitions from the second mode to the first mode in response to an increase in the hydraulic demand.

22. The system of claim 13, wherein the hybrid vehicle operates in the second mode when the vehicle speed is between 0 and 18 miles per hour.

23. The system of claim 1, wherein the transmission is an automated manual transmission.

24. The system of claim 1, wherein the hybrid vehicle does not operate in the second mode when a vehicle hood is open.

25. A method of operating a hybrid vehicle having a transmission with a transmission input shaft coupled by a clutch to an internal combustion engine, the transmission input shaft further coupled to a drive shaft of an electric traction motor through a transfer gear set coupled to a power take-off port of the transmission, the method comprising:
enabling a control system receiving data from sensors monitoring operations of the hybrid vehicle and generating drivetrain data;
enabling a first CAN control node communicating the drivetrain data with an electronic clutch actuator, a transmission control module, and a controller area network;
enabling a second CAN control node communicating the drivetrain data with the transmission control module, and the controller area network;
enabling an electric operating mode of the hybrid vehicle in response to an electric drivetrain mode signal;
communicating a simulated clutch position and a simulated clutch current between the transmission control module, the first CAN control node, the second CAN control node, and the controller area network in response to the electric drivetrain mode signal;
signaling the electronic clutch actuator to disconnect the internal combustion engine from the transmission input shaft in response to the electric drivetrain mode signal;
communicating a simulated engine speed between the transmission control module, the first CAN control node, the second CAN control node, and the controller area network in response to the electric drivetrain mode signal; and,
signaling the internal combustion engine to shut down in response to the electric drivetrain mode signal.

26. The method of claim 25, wherein receiving data from the sensors monitoring operations of the hybrid vehicle further comprises determining at least one of a vehicle run time, an engine coolant temperature, a battery voltage, an air pressure, an energy storage system state of charge, and a vehicle speed.

27. The method of claim 25, further comprising communicating a modified engine RPM speed data that the internal combustion engine is operating at a predetermined baseline idle RPM speed to the transmission control module.

28. The method of claim 26, further comprising terminating the electric drivetrain mode signal when the vehicle speed is greater than 30 MPH.

29. The method of claim 25, further comprising communicating a simulated clutch position feedback between 100 and 120 degrees between at least the first CAN control node and the electronic clutch actuator.

30. The method of claim 25, further comprising communicating a simulated clutch motor current between 35 and 45 Amps between at least the first CAN control node and the electronic clutch actuator.

31. The method of claim 25, further comprising communicating a modified accelerator pedal percent data between at least the transmission control module and the controller area network.
